(19) United States
(12) Patent Application Publication
(10) Pub. No.: US 2011/0294082 A1
(43) Pub. Date: Dec. 1, 2011

(54) METAL HEAT TREATING METHODS AND DEVICES

(76) Inventors: Igor Mikhaylovich Distergeft, Ekaterinburg (RU); IIIe Igoravich Distergeft, Ekateringburg (RU)

(21) Appl. No.: 12/197,577

(22) Filed: Aug. 25, 2008

(30) Foreign Application Priority Data
Feb. 26, 2006 (RU) PCT/RU2007/000008

(51) Int. Cl. F27B 21/00; F24C 3/00; F23C 7/00

(52) U.S. Cl. 432/4; 431/2; 432/120; 126/85 R

(57) ABSTRACT

The invention and its group of variants consists of metal heat treating methods, a method for the combustion of liquid or gaseous fuel and hot air in a directly or indirectly fired furnace, and a heating device and regeneration nozzles for the carrying out of said method. The invention, and its variants, relate to the field of metallurgy and mechanical engineering, and can be used for metal heat processing (e.g., melting, heating for deformation, heat treatment) and for the sintering, drying (and other types of heat treatment) of non-metallic products such as ceramics. The essence of the invention are the novel technical features that make it possible to attain, while implementing the invention, the air excess factor (α) values in fuel and hot air mixture that are greater than 2.0 and mainly set within a range equal or less than 6.0. Said invention makes it possible to reduce the waste of metal, during the processing thereof, in a directly or indirectly fired furnace, and to decrease the metal hydrogenation levels, including aluminium, titanium and iron alloys. The use of the invention in indirectly fired furnaces makes it possible to extend the service life of radiant tubes and melting pots. Experimental data obtained by the inventors prove that the technical result is attained by the respective composition of the atmosphere (gaseous phase) of the combustion products of liquid or gaseous fuel and hot air mixture where the air excess factor (α) values are greater than 2.0.

### CROSS-REFERENCE TO RELATED APPPLICATION

This application claims the benefit of the priority filing date in PCT/RU2007/00008 referenced in WIPO Publication WO 2007/097663. The earliest priority date claimed is Feb. 26, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention comprises an invention with several variants pertaining to metallurgy and mechanical engineering. The invention may be used for the heat treatment (e.g., melting, heating for deformation, heat treatment) of metals in combustion furnaces, directly fired with gas or liquid fuel. Upon the heating of metals, the end products of fuel combustion are in contact with the material (product) being heated, i.e. with the load. The invention may also be used for the heat treatment of metals in indirectly-fired furnaces. In these furnaces, warmth from the flame and combustion products is transferred to the heated material or product (load) through the walls of metal radiant tubes or melting pots. The invention may also be used for burning, baking and other types of heat treatment of non-metal products such as ceramics.

Prior Art. The known method of steel heating (heat treatment) in a directly-fired furnace (open-flame furnaces) is based on combustion of a mixture of gas fuel, and air in a heated area. The heated area is at the same time used as a furnace proper. For the complete use (combustion) of fuel, fuel is burned at an air excess factor close to one (α≅1.0), i.e., at standard stoichiometric fuel-to-air ratio [B. Φ [symbol] , [symbol] , [symbol] M., 1955, cTp. 152-153 (V. F. Kopytov, Steel Heating in Furnaces, Metallurgizdat, M., 1955, pages 152-153)]. In the case of a mixture in a blast furnace where natural gases are used, for instance, as fuel (calorific value 2,000 kcal/m³) at α=1.05-1.15, the volume of air fed to the burner is 2.25 times larger than the volume of fuel. And in cases where natural gas is used as fuel at the same value of α, the volume of consumed air is about ten times larger than the volume of natural gas.

This method has the following defective features. Burning results in the loss of a significant amount of treatable metal located in the furnace proper. This happens because the oxidizing medium of combustion products having an effect on treatable metal, in the furnace proper where the metal is located, is also used as the heating source of the furnace [above-mentioned work of V. F. Kopytov, pages 5-6, 162-163].

Upon the heating of steel in a directly-fired forge, the waste of metal in rolling and heat-treatment furnaces may reach a level of 2÷5%. At the scale of steel making in Russia, this equals a waste of more than 2 million tons of steel per annum. Moreover, there are the additional costs of machining and the removal of scale from the products. Scale may be removed using various methods: water descaling, etching, use of sandblast machines, brushes, etc.

Apart from the waste of metal in direct heat (thermal) treatment via the combustion of fuel in the furnace proper (at the air excess factor falling within the range of 0.9-1.2), surface layers of steel blanks are ultimately de-carbonized [ [symbol] , [symbol] [symbol] , [symbol] [symbol] [symbol] [symbol] [symbol] [symbol] [symbol] [symbol] [symbol] , [symbol] [symbol] [symbol] [symbol] [symbol] [symbol] [symbol] , [symbol] [symbol] [symbol] , [symbol] [symbol] , 1960, [symbol] 87, [symbol] 6 (K. M. Pakhaluev, V. I. Medvedeva, Study of Steel Oxidation and Decarbonization in Products of Natural Gas Combustion, collected book Heating of Metal and Operation of Heating Furnaces, collection of scientific papers No. 6, Metallurgizdat, Sverdlovsk Branch, 1960, page 87, FIG. 6]. Depending on the steel grade and heating temperature, de-carbonization can extend to depths of up to 3.0 mm. The de-carbonization of surface layers of steel products results in abating, a decrease in resistance to cyclic loads, and a deterioration of tool cutting power. The removal of the decarburized layer from the end products via continuous scarfing and burnishing results in material losses of metal and an increase in production costs.

Another defective feature is the fact that upon the heating of titanium alloys (for example, using the specified method) not only is there considerable waste of metal, the hydrogen absorption of products occurs at a significant depth. Thus, the content of hydrogen in a sample of Ti—5Al—1.7V alloy with a diameter of 30 mm (upon heating for 10 hours in an electric furnace and combustion furnace heated with natural gas at the air excess factor α equaling to 1.25), increases from 0.007% up to 0.025%, i.e., 3.6 times. [ [symbol] , [symbol] , [symbol] , [symbol] [symbol] [symbol] [symbol] [symbol] [symbol] [symbol] [symbol] , [symbol] [symbol] [symbol] , [symbol] , 1980, [symbol] . 57÷62 (S. N. Khomov, M. A. Grigoriev, S. M. Shulkin, Hydrogen Absorption of Titanium Alloys upon Heating in Combustion Furnaces, Tekhnologiya Legkikh Splavov, No. 2, 1980, pages 57÷62)].

The decision to use directly- and indirectly-fired furnaces instead of electric ones is dictated by the lower production costs of heat treatment in combustion furnaces. However, the production of wrought titanium, semi-finished products using well-known directly-fired furnaces requires a considerable increase in machining allowances and costs for the inspection of hydrogen content close to the surface and on the cross section of a heat treated product. Exceeding the maximum and safely accepted values of hydrogen concentration would result in a decrease in impact strength and an increase in metal tendency to static fatigue. To remove the surplus hydrogen from metal, long-term vacuum annealing is used. This leads to a significant appreciation of end products.

The method of heat treatment (heating) of steel in directly-fired furnaces is offered and can be used to reduce metal waste and the de-carbonization of steels. This method is based on a combustion of gas fuel and air mixture. The fuel is burned at an air excess factor of less than one (the so called non-oxidation or low-oxidation heating) [ [symbol] , [symbol] [symbol] , [symbol] [symbol] [symbol] [symbol] [symbol] [symbol] [symbol] [symbol] [symbol] [symbol] , [symbol] [symbol] [symbol] [symbol] [symbol] [symbol] [symbol] , [symbol] [symbol] , [symbol] [symbol] [symbol] [symbol] [symbol] 1960, [symbol] 91 (K. M. Pakhaluev, V. I. Medvedeva, Study of Steel Oxidation and Decarbonization in Products of Natural Gas Combustion, collected book Heating of Metal and Operation of Heating Furnaces, collection of scientific papers No. 6, Metallurgizdat, Sverdlovsk Branch, 1960, page 91), as well as the above-mentioned work of V. F. Kopytov, page 185].

A defective feature of low-oxidation heating consists of an increase in the content of carbon monoxide (CO) in the combustion products due to an incomplete combustion of fuel. This results in substantial capital costs and waste of fuel. It is therefore necessary to seal the whole structure of a directly-fired furnace to ensure gas-tightness of the wall lining, furnace roof, and bypass channels, as well as to create systems for the after-burning of combustion products.

In accordance with the published results of a study of metal oxidation processes in the presence of a flame, the heating volume of the oxidized metal at temperatures exceeding 800° C. increases. It matches the increase in the air excess factor α within a range of 0.8 to 1.6 [ [symbol] [symbol] , [symbol] [symbol] , [symbol] [symbol] [symbol] [symbol] [symbol] [symbol] [symbol] [symbol] [symbol] [symbol] , [symbol] [symbol] [symbol] [symbol] [symbol] [symbol] [symbol] , [symbol] [symbol] , [symbol] [symbol] , [symbol] [symbol] [symbol] , 1960 [symbol] . 80÷91 (K. M. Pakhaluev, V. I. Medvedeva, Study of Steel Oxidation and Decarbonization in Products of Natural Gas Combustion, collected book Heating of Metal and Operation of Heating Furnaces, collection of scientific papers No. 6, Metallurgizdat, Sverdlovsk Branch, 1960, pages 80÷91)]. Earlier similar studies were conducted within a range of values of α factor equaling 0.88÷1.32 [ [symbol] , [symbol] [symbol] [symbol] [symbol] , [symbol] [symbol] [symbol] [symbol] [symbol] [symbol] [symbol] , 1936, [symbol] . 44 (M. A. Glinkov, Rolling and Forge Furnaces, Joint Scientific and Technical Publishing House Sverdlovsk-Moscow, 1936, page 44)]. According to these publications, the value of burning loss reaches its maximum level when the air excess factor reaches values ranging from 1.2 to 1.6. The waste of metal also increases with an increase in heating temperature. It is believed [the above-mentioned work of V. F. Kopytov, page 182, and [symbol] [symbol] , [symbol] [symbol] [symbol] [symbol] [symbol] [symbol] , [symbol] , 1962, [symbol] . 159-160 (M. A. Kasenkov, Heating Devices of Forging Production, Mashgiz, 1962, pages 159-160)] that upon fuel combustion with an air excess factor exceeding 1.1-1.2, the volume of burning loss does not change. This is explained by the fact that the “rate of scale formation does not depend on the air excess factor because the oxidation process starts to be controlled not by the intensity of the approach of oxidizing gas molecules to the surface of products, but by the diffusion of oxygen through the surface layer of scale to metal” [the above-mentioned work of V. F. Kopytov, page 182]. This is also explained by the fact that the “scale crust is saturated with oxygen, that is why a further increase in oxygen content in furnace gases does not materially affect the oxidation rate” [the above-mentioned work of M. A. Kasenkov, pages 159-160].

Furthermore, it is known that upon the mixing of fuel with cold air (ambient temperature), the air excess factor has a limit value in terms of combustion (αₗᵢₘ) [ [symbol] [symbol] [symbol] , [symbol] [symbol] [symbol] [symbol] [symbol] [symbol] [symbol] , M.: [symbol] , [symbol] , 1986, [symbol] . 34 (F. G. Gainullin and others, Natural Gas as Engine Fuel for Transport, M.: Nedra, 1986, page 34)]. The value of αₗᵢₘ factor amounts to 2.0 for methane, 1.7 for propane, 1.8-2.0 for natural gas, and 1.65-1.75 for petrol. Therefore, (as it is specified in disclosure to RF patent No. 2098717) at such values of air excess factor there will be local areas in which the air-and-fuel mixture will not burn. This reduces the efficiency of power units. That is why the method of fuel combustion with a specified cold air excess factor has not become commonly used.

It is difficult to employ a fire-heating process at increased values of the air excess factor without preheating air because of a drop in temperature of the combustion products therewith and, therefore, in the operating temperature of the furnace. This happens because the supply of large volumes of “cold” air temperature (20-30° C.) is many times lower than the temperature of combustion products to the burner and the hearth.

A known method consists of heating a furnace comprised of chambers in stages of preheating, final heating and metal holding [RF patent No. 2139944]. This consists of a method of steel heat treatment in directly-fired furnaces using heating by secondary air. The method is based on the combustion of a mixture of gas fuel, and air. It includes the supply of fuel, a subsequent incomplete combustion at factors of primary air consumption (excess) (αᵢ equaling to 0.30-0.40) over the intermediate bottom of the final heating chamber, a supply of the secondary air for a complete after-burning of the total volume of incomplete combustion products, and a heating of the primary air under a high heat-conductive, intermediate bottom. During the process of heating the primary air, the temperature of the completed combustion products in the work space of the preheating chamber is maintained at a level not exceeding 500-550° C. The combustion of 10-100% of the total consumption of fuel used in the final heating chamber over the intermediate bottom is incomplete. The remaining volume of fuel is completely burned under the intermediate bottom. Incomplete combustion products supplied from the above-bottom space are after-burned with the secondary air. As such, the total proportioning of fuel and air consumption is close to stoichiometric values (α₂ is equal to 1.05-1.10).

The specified method includes an operation that consists of the following: upon the incomplete combustion of 60-100% of the fuel over the intermediate bottom (in the sub-bottom space of the chamber of final heating and holding), only the secondary air is supplied to the burners in the heating area. In the remaining burners, the fuel is burned at a equaling 1.05-1.10. In the holding area, the burners are off. Upon the incomplete combustion of 10-60% of fuel over the intermediate bottom (in the sub-bottom space of the holding area), the fuel is completely burned at factors of air consumption (excess) that are close to stoichiometric values. In the heating area, the fuel is burned under conditions of significant excess of air (α equals to 1.10/2.00). The excess air is used as the secondary air for the after-burning of the incomplete combustion products.

That is, if the method of metal heat treatment is employed in accordance with RF patent No. 2139944, air-and-fuel mixture would be burned at a factor of secondary air excess up to 2.0. In the patent disclosure for this invention, air excess corresponding to α equaling 1.10-2.00 is considered a significant excess of air. Moreover, the disclosure specifies that “the fuel-supply system of some burners in the sub-bottom space of the final heating chamber are turned off because, otherwise, to ensure complete combustion of fuel and after-burning of the incomplete combustion products, it would be necessary to supply secondary air at flow rates exceeding 2.0 to the burners of the sub-bottom space. This is associated with a significant depletion of gas-and-air mixture (less than 5% of fuel) and possible extinguishing of the burners.” The disclosure is also consistent with the existing belief that it is not necessary, and even impossible, to use high values of the secondary air excess factor upon the heating of metal.

The known method of natural gas combustion in high-temperature industrial, directly-fired furnaces (mainly in tunnel kilns) used, in particular, for the burning of zirconium products [RF patent No. 2099661], appears to be a method of heat treatment of metal in a combustion furnace. The method includes the supply of air blast to the furnace volume (heated space) within a fuel jet (primary fuel-and-air mixture) and the addition of hot, namely, heated secondary air, to a primarily fuel-and-air mixture in the mentioned furnace volume. This ensures a certain value of air excess factor.

According to the disclosure to RF patent No. 2099661, as a result of employing such a method, an oxidizing medium of combustion products is created in the furnace operating channel (work space) with treatable products that form an extension of the furnace volume. Air emissions of carbon monoxide (CO) are reduced to a minimum (as mentioned above, it also occurs upon low-oxidation heating with values of air excess factor lower than one). In other words, this confirms the preconceived notion mentioned above that the oxidizing ability of combustion products does not decreases at increased values of air excess factor.

Another known method of fuel combustion in a tunnel furnace [RF patent No. 2166161] also appears to be a method of heating a directly-fired tunnel furnace. This includes the combustion of fuel and air mixture in a heated area (furnace volume) and the transfer of the combustion products to the furnace proper. This method is employed upon the annealing of ceramic products. It also can be used in the heating of a combustion furnace for the heat treatment of metal. The method includes the supply of fuel-and-air mixture and secondary air to the furnace volume and their combustion at air excess factors ranging from 0.75 to 1.5. In addition, secondary air is added to the fuel-and-air mixture containing 0.1÷0.2 cm of heated or unheated primary air per 1 MJ of fuel energy. The secondary air is added in the amount of 0.1÷0.2 cm per 1 MJ of energy at a temperature of 700÷1,400° C.

At α equaling 0.75÷1.0, the method under consideration ensures the obtainment of a low-oxidizing medium in the combustion products, and at α equaling 1.0÷1.5, it ensures that an oxidizing medium is obtained. The choice of the type of medium in a furnace is determined by its necessity in treating the relevant product.

The defective features of the specified method for the heat treatment of metal are as follows: the maximum level of metal waste is determined by the composition of the combustion products (upon the use of the oxidizing medium, i.e. at a equaling to 1.0÷1.5), especially at elevated temperatures, as well as (upon the use of the low-oxidizing medium) the hydrogen absorption of titanium and its alloys (for example, the high concentration of carbon monoxide due to the incomplete combustion of fuel), and the waste of fuel. A high concentration of carbon monoxide makes it necessary to seal the structure of the combustion furnace and requires substantial capital costs.

As specified in the description of the method under consideration, according to RF patent No. 2166161, the range of a values falling within the limits of 0.75 to 1.5 is sufficient for industrial practice. It is also consistent with the above-mentioned existing opinion concerning the unnecessary use of higher values of a factor upon the heat treatment of metals. It also accords with absence of information concerning the heating of metal in combustion furnaces at values of air excess factors exceeding 1.6÷2.0 in the technical literature.

One more known method of heat treatment of metal in a indirectly-fired furnace presupposes the separation of combustion products from the metal being heated, in particular, using flame muffling—combustion of fuel and air in the heated space inside a radiant tube (muffle) [U.S. Pat. No. 4,878,480, F24C 003/00, 126/91A, 431/353, 432/209]. In addition, the heating of metal in the work space outside the radiant tube is performed via radiation from the outer walls of the radiant tube heated from the inside.

When employing this method of indirect heating, the treatable metal in the work space outside the radiant tube is not located in the medium of combustion products, and is not subject to heating load and/or hydrogen absorption. However, the metal of inner walls of radiant tube located in the heated space and exposed to the impact of combustion products is wasted. It shortens the service life of the radiant tube, increasing the operating expenses and production costs of metal treatment. These are defective features of the described method of indirect radiant heating in a combustion furnace.

There is another known method of heat treatment of metal in an indirectly-fired furnace. In this case, fuel and air mixture is burned in the heated space outside the melting pot (muffle) in the work space where the treated metal is located. The metal in work space inside melting pot is heated via radiation from the inner walls of the pot [for example, application for RF utility patent No. 93052328, published on Sep. 27, 1996]. Sometimes the work space of the pot is filled with shielding gas. This method of indirect heating also has a defective feature that is similar to the above-mentioned method. It involves a shorter service life of the pot's outer metal walls which are exposed to the impact of the combustion products.

The closest to the offered method (prototype) is a method of heating of regeneration pit furnaces [USSR Inventor's Certificate No. 1257110]. In actuality, it is a method of metal heat treatment in a directly-fired furnace in the form of a regeneration pit. This method is based on the combustion of a mixture of fuel and air that is preheated in a regenerative chamber. In this method, fuel and air mixture is burned directly in the furnace proper. In the example of how this method works, 3,800 cm/h of blast furnace gas and 120 cm/h of natural gas as well as 4,150 cm/h of heated air are supplied to the burner. This ensures an air excess factor α equaling about 1.1. Another variant of this prototype method is a method of metal heat treatment in an indirectly-fired furnace according to which fuel and heated air mixture is burned in the heated space of a radiant tube [ [symbol] . [symbol] , [symbol] [symbol] , [symbol] [symbol] , [symbol] [symbol] [symbol] [symbol] [symbol] [symbol] [symbol] , [symbol] [symbol] [symbol] [symbol] [symbol] , “ [symbol] ”, 2000, [symbol] , [symbol] . 87-88, [symbol] . 5 (I. M. Distergeft, G. M. Druzhinin, V. I. Shcherbinin, Experience of All-Union Scientific Research Institute of Metallurgical Heat Engineering in Development of Regenerating Heating Systems for Metallurgical Plants, “Stal”, 2000, No. 7, pages 87-88, FIG. 5)]. Metal in the work space is heated via convection from the outer walls of a radiant tube heated from the inside.

In the first variant prototype of the invented method, a rise in temperature of the combustion products (and, consequently, in the operating temperature of the furnace) and a reduction of fuel consumption are ensured by means of preheating air, as compared with similar methods.

A defective feature of the method of metal heat treatment prototype in a directly-fired furnace is that the maximum level of burning loss and/or hydrogen absorption of metal is located in the heated work space of the combustion furnace. Burning loss, especially at elevated temperatures, results in a waste of metal upon heat treatment. Hydrogen absorption of metals, mainly of non-ferrous metals (for example, titanium and its alloys), deteriorates the properties of these metals. As practice and research prove, results are determined by the relevant known composition of the combustion products which include some content of carbon dioxide and water and oxygen vapor (oxidizing medium). Upon heat treatment, they affect the heated metal which results in the burning loss and hydrogen absorption of metals.

A defective feature of the method of heat treatment prototype in an indirectly-fired furnace is the wasting of the metal in the muffle walls located in the heated space of an indirectly-fired furnace (inner surfaces of the radiant tube or the outer surface of the pot). Burning loss is determined by the reasons mentioned in the above paragraph. It leads to a shorter service life of the radiant tube (pot), and an increase in operating expenses and production costs of metal treatment.

Furthermore, with the use of limit values of the air excess factor in this method of metal heat treatment in a combustion furnace, a limited amount of fuel-and-air mixture is supplied to the heated space of the furnace (and to the radiant tube). This also limits the rate of movement of the combustion products in the heated space or inside the radiant tube. This results in a decreased value of the convectional component of heat exchange, a longer time for heating the treatable metal and non-metal products, and a reduced capacity of the furnace. A limited rate of movement of the combustion products also results in a non-uniform distribution of temperatures, both in the furnace proper and in the load (products subject to heat treatment). It degrades the quality of heat treated products.

Another variant of the prototype method is currently in use. It is a multistage method of metal heat treatment in an open-flame furnace (direct heating). This method is based on the combustion of fuel and preheated air mixture at an air excess factor of up to 1.2 [the above-mentioned work of M. A. Kasenkov, pages 173-174, 162, 160]. This method includes at least three stages of heating (stage heating): heating at low temperatures (to intermediate temperature between 650-850° C.) with holding at the intermediate temperature, heating at high temperatures (i.e., at temperatures exceeding 850° C.) to operating temperature with holding at the operating temperature.

A defective feature of this prototype variant (method with multistage heat treatment of metal upon direct heating) is the high level of metal waste, especially at the elevated temperatures, and the hydrogen absorption, particularly of non-ferrous metals. In other words, there is a corresponding deterioration of the metal's properties.

The specified known multistage method of metal heat treatment may also be employed upon indirect heating with use of muffles (for example, radiant tube or pot). A defective feature of the multistage prototype method of metal heat treatment in an indirectly-fired furnace is the waste of metal in the muffle walls (radiant tube, pot) located in the heated space of an indirectly-fired furnace. This shortens the service life of the muffle and increases the operating expenses and production costs of metal treatment.

Furthermore, with the use of limit values of air excess factor in the multistage method of metal heat treatment in combustion furnaces, a limited amount of fuel-and-air mixture is supplied to the heated space of the furnace (and to the radiant tube). This also limits the rate of movement of combustion products in the heated space or inside the radiant tube. This results in a decreased value of the convectional component of heat exchange, a longer time of heating the treatable metal and non-metal products, and a reduced capacity of the furnace. A limited rate of movement of the combustion products also results in a non-uniform distribution of temperatures both in the furnace proper and in the load (products subject to heat treatment). This degrades the quality of heat treated products.

The objective of the invention—the first and the second variants of the methods of metal heat treatment in directly- and indirectly-fired furnaces—consists of the reduction of waste from the treatable metal and the lowering of the level of hydrogen absorption of the treatable metals, including alloys of aluminium, titanium, and ferrum, upon direct heating. Upon indirect heating, the aim is to extend the service life of the muffle (radiant tube, pot) to reduce the operating expenses and production costs of metal treatment. Moreover, the objective of the invention is to increase the furnace output and to improve the quality of heat treatment of metal and non-metal products.

The already mentioned method of natural gas combustion in high-temperature industrial, directly-fired furnaces (mainly in tunnel kilns) used, in particular, for burning of zirconium products [RF patent No. 2099661], is currently in use. It includes the supply of air blast to the furnace volume (heated space) within a fuel jet (primary fuel-and-air mixture), and the addition of hot air, namely heated secondary air, to the primary fuel-and-air mixture in the furnace volume at some value of the air excess factor.

The method of fuel combustion in a directly-fired tunnel furnace [RF patent No. 2166161] is the closest to the offered third variant of the invented method. The former includes the combustion of fuel and air mixture in the heated space (furnace volume) and the transfer of combustion products to the furnace proper. This method includes the supply of fuel-and-air mixture and secondary air to the furnace volume and their combustion at air excess factors ranging from 0.75 to 1.5. In the case where a equals 0.75÷1.0, the method under consideration ensures the obtainment of a low-oxidizing medium in the combustion products. If a equals 1.0÷1.5, it ensures the obtainment of the oxidizing medium. The choice of the type of medium in a furnace is dictated by its necessity for treating the relevant product. The method is employed when annealing ceramic products. It can also be used for the heating of the combustion furnace upon heat treatment of metal, as well as upon the indirect heating of treatable products using a radiant tube or pot.

If values used in the air excess factor do not exceed 1.5, this method presupposes that a limited amount of fuel-and-air mixture is supplied to the heated space of the furnace (or to the radiant tube), which also limits the rate of movement of the combustion products in the heated space and radiant tube. This results in a decreased value of the convectional component of heat exchange, a longer time for heating the treatable metal and non-metal products, and a reduced capacity of the furnace. The limited rate of movement of the combustion products also results in a non-uniform distribution of temperatures, both in the furnace proper and in the load (products subject to heat treatment). This degrades the quality of the heat treated products.

The defective features of the specified method for heat treatment are the following: highest level of metal waste based on the composition of combustion products (upon use of oxidizing medium, i.e. at a equaling to 1.0÷1.5), especially at elevated temperatures, as well as (upon use of low-oxidizing medium) the hydrogen absorption of titanium and its alloys, for example, high concentration of carbon monoxide due to incomplete combustion of fuel, and a waste of fuel. High concentration of carbon monoxide makes it necessary to seal the structure of the combustion furnace and requires substantial capital costs.

The objective of the third variant of the invented method—method of combustion of a mixture of liquid or gas fuel and heated air in a combustion furnace at a certain value of the air excess factor—is to increase the furnace output and to improve the quality of heat treatment of the metal and non-metal products, as well as to reduce burning loss, de-carbonization and hydrogen absorption of the heated metals.

Regeneration combustion furnaces fitted with the relevant devices for the heating of these furnaces are used to implement the above-specified known methods of heat treatment of metals and non-metals in directly- or indirectly-fired furnaces, as well as the method of combustion of mixture of liquid or gas fuel and heated air in direct- or indirect-fired furnaces.

The following device for the heating of a directly-fired furnace is currently in use [RF patent No. 2190170]. It includes a working chamber (heated, also referred to as the work space) with windows (ducts) for the removal of hot combustion products, two burners for the burning of gas fuel mixed with preheated air at a stoichiometric ratio of fuel to heated air, and a system of air heating and supply to each burner in the required amount. The stoichiometric ratio is characterized by a value of heated air excess factor equaling one. The system of air heating and supply includes two regenerators that are in turn heated by the combustion products which are also in turn supplied with heated air. This air is then supplied to the burners (double-cycle pulse mode of operation of the system for the heating of the combustion furnace). The system has connecting pipes and ducts with reversing (shut-off) valves to ensure an alternating flow of combustion products and air through regenerators and the removal of combustion products to a fume-collecting system. The pipes and ducts are accordingly connected to regenerators, burners and a fume-collecting system. The stoichiometric ratio of volumes of gas fuel to volumes of heated air burned in the system (α≈1) is ensured by its relevant design. In particular, it is ensured by the relationship between the parameters that characterize cross-sections of the pipelines for fuel and air supply to the burners. Another design feature of the device that ensures a supply of the required amount of heated air to the burners consists of implementing the regenerating headpiece, the volume of the interior space, the required volume (weight) of heat-transfer elements filling the interior space, and the material of the heat-transfer elements, for example, fire brick [ [symbol] [symbol] [symbol] , [symbol] [symbol] [symbol] , M., 1951, [symbol] . 665 (V. A. Baum and others, Metallurgical Furnaces, M., 1951, page 665)] or metal [the above-mentioned work: [symbol] [symbol] , [symbol] [symbol] [symbol] [symbol] [symbol] [symbol] , [symbol] , 1962, [symbol] . 296 (M. A. Kasenkov, Heating Units in Forging Production, Mashgiz, 1962, page 296)].

A defective feature of this device (for metal heat treatment with direct heating, the design of which ensures combustion of fuel and air mixture at their stoichiometric ratio (α=1)), consists of a waste of a significant amount of metal due to burning loss resulting from the oxidizing medium of the combustion products in the heated (work) space and from the hydrogen absorption of the metals.

A device for metal heat treatment in an indirectly-fired furnace [U.S. Pat. No. 4,878,480] is also currently in use. It includes a heated space in the form of a radiant tube with two burners for the burning of gas fuel mixed with air, and fitted with windows for the removal of combustion products.

Upon using the specified device for indirect heating in a combustion furnace, treatable metal in the work space outside the radiant tube is not located in the medium of the combustion products, and is not subject to burning loss and/or hydrogen absorption. However, metal from the inner walls of the radiant tube located in the heated space, and exposed to the impact of the combustion products, is wasted. It shortens the service life of the radiant tube and increases the operating expenses and production costs of metal treatment. These are defective features of the described device.

Another device for metal heat treatment in an indirectly-fired furnace [application for RF utility patent No. 93052328, published on Sep. 27, 1996, C21C 5/28] is currently in use. It includes heated space with a window for the removal of combustion products (ladle volume), several burners for the burning of gas fuel mixed with air at a certain ratio of fuel to heated air, and a pot (with scrap metal subject to melting) located in the heated space.

A defective feature of this device consists of a shorter service life of the pot's outer metal walls, which are exposed to the combustion products, and, consequently, an increase in the operating expenses and production costs of metal treatment.

The device for the heating of an open-flame furnace (direct heating) for the non-oxidation heating of steel blanks is the closest to the first variant of the invented device [the above-mentioned work: [symbol] [symbol] , [symbol] [symbol] [symbol] [symbol] [symbol] [symbol] , [symbol] , [symbol] , 1962, [symbol] . 296-297, [symbol] . 178 (M. A. Kasenkov, Heating Units in Forging Production, Mashgiz, 1962, pages 296-297, FIG. 178)]. It includes a heated space, also referred to as the work space, with windows (ducts) for the removal of hot combustion products, two burners for the burning of gas fuel mixed with preheated air, and a system for the heating of air and supply of air to at least one of burners in the required amount. The burners work in turns, in a cyclic pulse mode. The mixture is burned at a fuel-to-heated air ratio characterized by a value of heated air excess factor being less than one (low-oxidation heating). The system of air heating and supply includes two regenerators (regenerating headpieces). During one operation cycle of the device for the heating of a combustion furnace, each of the regenerating headpieces is used for heating the heat-transfer elements using hot combustion products. During the other cycle, each of the headpieces is used for the heating of air using heat-transfer elements that were heated during the previous cycle. The device has a system of control and exchange. This system includes ducts with valves connected to regenerating headpieces, burners, and a smoke exhauster. It ensures an alternating flow of the combustion products and airflow through the regenerating headpieces, a supply of heated air to at least one of two burners, and the removal of the combustion products from the smoke exhauster. In other words, the design of the system of control and exchange presupposes that the regenerating headpieces could perform cyclically changing functions.

The design of the device under consideration that ensures a supply of heated air in the amount required for low-oxidation heating to the burners (at set air excess factor being less than one) presupposes the presence of heat-transfer elements in the form of metal pipes or balls in the interior space of each of the regenerating headpieces. The volume (weight) of these elements is sufficient for the heating of the required volume of air in unit time.

Ensuring low-oxidation heating of the metal by the specified prototype device reduces a waste of metal. However, it does not prevent hydrogen absorption of titanium and its alloys, for example. It also has a defective feature. It consists of a high concentration of carbon monoxide due to the incomplete combustion of fuel in the heated space. It becomes necessary to seal the structure of the combustion furnace, which results in increased capital costs. In addition, the process of after-burning of the combustion products in the bottom part of the regenerators (which is implemented in this device) results in a waste of fuel.

Another kind of prototype of the first variant of the invention is a pilot device for the heating of a directly-fired furnace [ [symbol] [symbol] , [symbol] [symbol] , [symbol] [symbol] , [symbol] [symbol] [symbol] [symbol] [symbol] [symbol] [symbol] [symbol] [symbol] , [symbol] [symbol] , [symbol] , “ [symbol] ”, 2000, [symbol] , [symbol] . 86-87, [symbol] . 2 (I. M. Distergeft, G. M. Druzhinin, V. I. Shcherbinin, Experience of All-Union Scientific Research Institute of Metallurgical Heat Engineering in Development of Regenerating Heating Systems for Metallurgical Plants, “Stal”, 2000, No. 7, pages 86-87, FIG. 2)]. The device includes a heated space, also referred to as the work space (combustion chamber), a regenerating burner for the burning of gas fuel mixed with air (which operates in double-cycle pulse mode), a gas duct for the removal of cooled combustion products during one operation cycle, and flue for the removal of hot combustion products during the other operation cycle. It also includes a system for the heating of air and its supply (in the required amount) to the regenerating burner in the pulse mode, including a regenerating headpiece. The presence of the heat-transfer elements in the interior space of the regenerating headpiece ensures the heating of the required volume of air in unit time for the maintenance of the required air excess factor. During one operation cycle of the device for heating of a combustion furnace, the regenerating headpiece is used for heating the heat-transfer elements located in it using hot combustion products that are removed from the gas duct after cooling in the headpiece. During the other cycle, the headpiece is used for the heating of air using the heat-transfer elements heated during the previous cycle. The device has a system of control and exchange. This system includes ducts and valves. Its design presupposes that the regenerating headpieces could perform cyclically changing functions. During one cycle, the system of control and exchange ensures a flow of combustion products from the forehearth-mixing chamber to the regenerating headpiece for the heating of heat-transfer elements in the headpiece and the removal of the cooled combustion products from this cycle to the gas duct. During the other cycle, it ensures a supply of heated air through the regenerating headpiece in the opposite direction. The heated air mixed with fuel then goes to the regenerating headpiece to form the combustion products in the combustion chamber. The combustion products are transferred through the flue for beneficial use. The design of the system of control and exchange presupposes that the regenerating headpiece could perform cyclically changing functions.

A defective feature of this prototype of the first variant of the device (for metal heat treatment with direct heating) consists of a loss of a significant amount of metal from the load due to the burning loss and hydrogen absorption of the metals. Waste of metal occurs because of the oxidizing medium of the combustion products. When indirectly heating the device under consideration, a defective feature consists of a waste of metal from the muffle, which leads to a shorter service life of the muffle (radiant tube, pot) and an increase in the operating expenses and production costs of metal treatment. Furthermore, because limit values of air excess factor are used in the device for heating of combustion furnace, a limited amount of fuel-and-air mixture is supplied to the heated space of the furnace or to the radiant tube. This also limits the rate of movement of the combustion products in the heated space and the radiant tube, resulting in a decreased value of the convectional component of heat exchange, a longer time for heating the treatable metal and non-metal products, and a reduced capacity of the furnace. The limited rate of movement of the combustion products also results in a non-uniform distribution of temperatures, both in the furnace proper and in the load (products subject to heat treatment). This degrades the quality of the heat treated products.

The objective of the invented device for the heating of a directly- or indirectly-fired furnace according to the first variant is to reduce the burning loss, lower the level of hydrogen absorption of metals in the process of heat treatment in combustion furnaces (upon direct heating of the load) and extend the service life of the muffle (radiant tube, pot), reduce the operating expenses and production costs of metal treatment (upon indirect heating of the load), increase furnace output, and improve the quality of heat treatment of products.

A device for the heating of a directly-fired furnace is the closest to the second and the third variants of the invented device [ [symbol] [symbol] , [symbol] [symbol] , [symbol] [symbol] [symbol] , [symbol] [symbol] [symbol] [symbol] , [symbol] [symbol] [symbol] [symbol] [symbol] , [symbol] , 2005, [symbol] , [symbol] . 65-67, [symbol] . 1 (G. M. Druzhinin, I. M. Distergeft, V. A. Leontyev and others, Basic Trends in Reconstruction of Circular Furnace for Heating of Blanks, Stal, 2005, No. 3, pages 65-67, FIG. 1)]. The mentioned device includes a heated space that is also used as the work space for accommodating the heated metal, two burners for the burning of gas or liquid fuel (mixed with preheated air at a certain ratio of fuel to heated air characterized by a relevant value of the air excess factor), a system for the heating of air and its supply to each burner in the required amount, a duct for the supply of gas or liquid fuel, a duct for the removal of the cooled combustion products, as well as a system of control and exchange. The system for the heating of air and its supply to each burner in the required amount includes a duct for supply of air from the outside and two regenerating headpieces. Each of the headpieces has an interior space with two input-output windows filled with a layer of heat-transfer elements of a certain amount. During one operation cycle of the device for the heating of the combustion furnace, each of the regenerating headpieces is used for the heating of the mentioned heat-transfer elements with hot combustion products. During the other cycle, each of them is used for the heating of air using the heat-transfer elements heated during the previous cycle. During the one operation cycle of the device for heating of combustion furnace, each of the burners functions as a burner, and, during the other operation cycle of the device for heating of combustion furnace, each of them functions as window for the removal of hot combustion products from the heated space. In addition, the design of the system of control and exchange presupposes that the burners and the regenerating headpieces could perform cyclically changing functions. That is, during each operation cycle of the device for heating of the combustion furnace, the system of control and exchange ensures a connection of the duct for the supply of gas or liquid fuel with one of the burners, a connection of the other burner with one of the input-output windows of the interior space of one of the regenerating headpieces, a connection of the other input-output window of this regenerating headpiece with the duct for the removal of the cooled combustion products, a connection of the duct for the supply of air from the outside with one of the input-output windows of the interior space of the other regenerating headpiece, and a connection of the other input-output windows of this headpiece with the burner to which the duct for the supply of gas or liquid fuel is connected.

The volume of the layer of heat-transfer elements in the form of corund balls filling the interior space of each regenerating headpiece determines the capacity for the supply of heated air to each burner and the value of the air excess factor. The Air excess factor ensures the oxidizing medium in the heated space (where the metal subjected to heat treatment is located).

A defective feature of the described prototype of the second and third variants of the invented device (for the heat treatment of metal in a directly-fired furnace) consists of the waste of a significant amount of metal because of burning loss resulting from the oxidizing medium of the combustion products (a approximately equals to 1) and the hydrogen absorption of the metals.

Another kind of prototype device of the second and third variant of the invention is a device for the heat treatment of metal in an indirectly-fired furnace [ [symbol] [symbol] , [symbol] [symbol] , [symbol] [symbol] , [symbol] [symbol] [symbol] [symbol] [symbol] [symbol] [symbol] [symbol] [symbol] [symbol] [symbol] [symbol] , “ [symbol] ”, 2000, [symbol] , [symbol] 87-88, [symbol] 5 (I. M. Distergeft, G. M. Druzhinin, V. I. Shcherbinin, Experience of All-Union Scientific Research Institute of Metallurgical Heat Engineering in Development of Regenerating Heating Systems for Metallurgical Plants, “Stal”, 2000, No. 7, pages 87-88, FIG. 5)]. The mentioned device includes a heated space in the form of a radiant tube with two burners for the burning of gas or liquid fuel (mixed with preheated air at a certain ratio of fuel to heated air characterized by a relevant value of the air excess factor), a system for the heating of air and its supply to each burner in the required amount, a duct for the supply of gas or liquid fuel, a duct for the removal of the cooled combustion products, as well as a system of control and exchange. The system for heating of air and its supply to each burner in the required amount includes a duct for the supply of air from the outside and two regenerating headpieces. Each of the headpieces has an interior space with two input-output windows filled with a layer of heat-transfer elements of a certain amount. During one operation cycle of the device for heating of the combustion furnace, each of the regenerating headpieces is used for the heating of the mentioned heat-transfer elements with the hot combustion products. During the other cycle, each of them is used for the heating of air using the heat-transfer elements heated during the previous cycle. During the one operation cycle of the device for the heating of the combustion furnace, each of the burners functions as a burner, and, during the other operation cycle of the device for heating of combustion furnace, each of them functions as a window for the removal of hot combustion products from the heated space. In addition, the design of the system of control and exchange presupposes that the burners and the regenerating headpieces could perform cyclically changing functions. That is, during each operation cycle of the device for the heating of the combustion furnace, the system of control and exchange ensures a connection of the duct for the supply of gas or liquid fuel with one of the burners, a connection of the other burner with one of the input-output windows of the interior space of one of the regenerating headpieces, a connection of the other input-output window of this regenerating headpiece with the duct for the removal of the cooled combustion products, a connection of the duct for the supply of air from the outside with one of the input-output windows of the interior space of the other regenerating headpiece, and a connection of the other input-output windows of this headpiece with the burner to which the duct for the supply of gas or liquid fuel is connected. The volume of the layer of heat-transfer elements, in the form of corund balls filling the interior space of each regenerating headpiece, determines the value of the air excess factor. The air excess factor ensures the oxidizing medium in the heated space inside the radiant tube. The metal subject to heat treatment is located in the work space outside the radiant tube.

A defective feature of the described prototype of the second and third variants of invented device for the heat treatment of metal in an indirectly-fired furnace consists of the waste of metal from the walls of the radiant tube that are located in the heated space of the indirectly-fired furnace. This results in shortening the service life of the radiant tube and an increase in the operating expenses and production costs of metal treatment. Furthermore, because limit values of the air excess factor are used in the device for the heating of the combustion chamber, a limited amount of fuel-and-air mixture is supplied to the heated space of the furnace or to the radiant tube. This also limits the rate of movement of the combustion products in the heated space and the radiant tube, resulting in a decreased value of the convectional component of heat exchange, a longer time for heating the treatable metal and non-metal products, and a reduced capacity of the furnace. A limited rate of movement of the combustion products also results in a non-uniform distribution of the temperatures, both in the furnace proper and in the load (products subject to heat treatment). This degrades the quality of heat treated products.

The objective of the invented device for the heating of the combustion furnace according to the second and third variants consists of a reduction of the burning loss and the lowering of the level of hydrogen absorption of the load (treatable metals), including alloys of aluminium, titanium, and ferrum for directly-fired furnaces. The objective for indirectly-fired furnaces is to extend the service life of the radiant tube (pot) and to reduce the operating expenses and production costs of metal treatment. Moreover, the objective of the invention is to increase the furnace output and to improve the quality of the heat treatment of products.

In regeneration combustion furnaces for the heat treatment of metals heated with a burned mixture of liquid or gas fuel and heated air, regenerating headpieces are used. Each of these headpieces includes an interior space with two input-output windows filled with a layer of heat-transfer elements [for instance, the above-mentioned work of M. A. Kasenkov, pages 296-297, FIG. 178]. The design of the regenerating headpieces and principles of their operation are similar to known types of directly- and indirectly-fired furnaces. The regenerating headpiece is designed for operation in two cycles. During one cycle, the headpiece is used for the heating of heat-transfer elements using combustion products of the mixture being burned. During the other cycle, the headpiece is used for the heating of air using heat-transfer elements. When the regenerating headpiece is used in a combustion furnace, its input-output windows are connected with a duct for the supply of the hot combustion products (from the heated space of the combustion furnace through a corresponding switching system (reversing, shut-off valves)), a duct for the removal of the cooled combustion products, a duct for the supply of air, and a duct for the supply of heated air to the burner.

Known regenerating headpieces are designed for use in combustion furnaces for the heating of metals upon the burning of a mixture of fuel and air at their stoichiometric ratio (α=1), upon low-oxidation heating (a being less than 1), and in the usual current practice range of values of the air excess factor (as specified above they do not exceed 2.0). It anticipates the design defect of each of the known regenerating headpieces. It requires the presence of a certain amount of heat-transfer elements in the interior space of such a headpiece. The amount of heat-transfer elements is dictated by such volume of air heating as is required to ensure the combustion of fuel and air mixture in the burner(s), at a set value of the air excess factor falling within the specified range. After all, use of the known regenerating headpieces in combustion furnaces for the heating of metals causes a significant amount of metal waste due to burning loss resulting from the oxidizing medium of the combustion products, the de-carbonization of the surface layers of the blanks and the hydrogen absorption of metals.

The following regenerating headpiece of a combustion furnace (heated with a mixture of liquid or gas fuel and heated air) is the closest to the offered technical decisions. This headpiece includes an interior space with two input-output windows. The space is filled with a layer of heat-transfer elements in the form of metal or corund balls. During one operation cycle, the regenerating headpiece is used for the heating of the mentioned heat-transfer elements using the combustion products. During the other cycle, it is used for the heating of air using the heat-transfer elements heated during the previous cycle [ [symbol] [symbol] [symbol] [symbol] , [symbol] [symbol] [symbol] [symbol] [symbol] [symbol] [symbol] [symbol] , [symbol] [symbol] [symbol] [symbol] ( [symbol] [symbol] , [symbol] [symbol] [symbol] ), [symbol] [symbol] . [symbol] . [symbol] [symbol] [symbol] [symbol] , [symbol] 5, [symbol] [symbol] [symbol] [symbol] [symbol] [symbol] [symbol] [symbol] [symbol] [symbol] [symbol] , [symbol] [symbol] , 2002, [symbol] . 44÷57 (I. M. Distergeft and others, Regenerating Heating Systems for Heating Furnaces of Rolling and Forging Production (History of Development, Theory and Practice), collection of scientific papers Metallurgical Heat Engineering, Volume 5, Ministry of Education and Science of Ukraine/National Metallurgical Academy of Ukraine, Dnepropetrovsk, 2002, pages 44÷57)].

A design defect of the regenerating headpiece under consideration, along with the above-mentioned headpieces, consists of the presence of a certain amount of heat-transfer elements in the interior space. The amount of heat-transfer elements is dictated by such volume of air heating as is required to ensure the combustion of fuel and air mixture in the burner(s) at a set value of the air excess factor falling within the usual known range specified above (value of a does not exceed 2.0). Use of this regenerating headpiece in combustion furnaces for the direct or indirect heating of metals causes waste of metal in the load or muffle due to the burning loss and hydrogen absorption of the metals. Like its use in the combustion furnace, the specified known regenerating headpiece ensures a supply of limited volumes of fuel-and-air mixture to the heated space of the furnace or to the radiant tube (due to the limited volume of heat-transfer elements, the limited rate of movement of the combustion products in the heated space of the furnace, and the limited radiant tube). This results in a decreased value of the convectional component of heat exchange, a longer time to heat the treatable metal and non-metal products, and a reduced capacity of the furnace. A limited rate of movement of the combustion products also results in a non-uniform distribution of the temperatures, both in the furnace proper and in the load (products subject to heat treatment). This degrades the quality of heat treated products.

The objective of the invention—three variants of regenerating headpiece for a directly- or indirectly-fired furnace heated with a mixture of liquid or gas fuel and heated air—is to improve the quality of the metal (load) subject to heat treatment. This is ensured by reducing the metal waste in the process of its heat treatment in the combustion furnace and lowering the level of the hydrogen absorption of metals, including alloys of aluminium, titanium and ferrum. When the regenerating headpieces are used in directly-fired furnaces, the specified reduction of metal waste and hydrogen absorption refers to the metals and the products processed in furnaces (i.e., to the load). In the case of indirectly-fired furnaces, it refers to the metal walls of the radiant tubes or pots. In addition, the objective of the invention is also to extend the service life of the mentioned radiant tubes and pots, and to, accordingly, reduce the expenses for the treatment of metals and the production costs of the heat treatment of these metals.

Finally, the objective of the invention—three variants of the regenerating headpieces for the combustion furnace—is to increase the furnace output and to improve the quality of the heat treated products.

The specified objectives are common for all variants of the offered invention.

The specified objectives are attained with the help of the new technical solutions specified below: three variants of the method and several devices for the implementation of the method variants—three variants of the device for the heating of the combustion furnace and three variants of the regenerating headpiece of the combustion furnace.

### SUMMARY

The invention, including a group of variants, comprises methods of metal heat treatment and methods of burning mixtures of liquid or gas fuel and heated air in a directly- or indirectly-fired furnace, as well as heating devices and regenerating headpieces for the implementation of such methods. The invention, and its variants, pertains to the fields of metallurgy and mechanical engineering. They can be used both upon the heat treatment of metals (e.g., melting, heating for deformation, heat treatment) and upon the burning, baking and other types of heat treatment of non-metal products such as ceramic products.

The essence of the invention, and its variants, is reflected in new technical features ensuring the achievement of certain values of the air excess factor (a) where the mixture of fuel and heated air exceeds 2.0 and falls primarily within a range of up to 6.0 upon implementation of the invention.

The technical result upon the implementation of the invention consists of the reduction of metal waste in the process of its treatment in a directly-fired furnace (FIG. 4), and of the lowering in the level of hydrogen absorption of metals, including alloys of aluminium, titanium, and ferrum. Upon the implementation of the invention in indirectly-fired furnaces, the technical result consists of a longer service life of the radiant tubes and melting pots.

The experimental evidence obtained by the inventors demonstrate that the specified technical result is achieved on account of ensuring the relevant composition of the atmosphere (gas phase) of the combustion products, namely, the mixture of hot air and liquid or gas fuel at values of the air excess factor α exceeding 2.0.

### FIGURES

FIG. 1 is a block diagram of the device for heating of a directly-fired furnace for implementation of the first and second variants of the invention with regenerating headpieces in accordance with the first variant;

FIG. 2 is a graph of metal waste (Y-axis, g/cm²) against air excess factor α (X-axis, a non-dimensional value) upon heating of St 10 steel specimens;

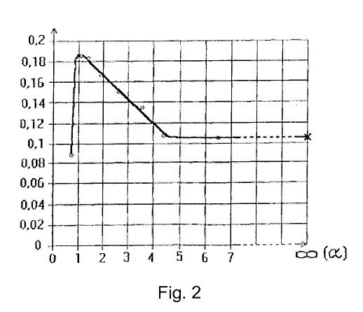

FIG. 3 is a graph of concentration of oxygen O₂, carbon dioxide CO₂ and water vapor H₂O (Y-axis, %) against air excess factor α (X-axis, a non-dimensional value);

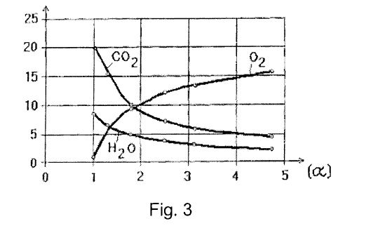

FIG. 4 is a graph of metal waste (Y-axis, g/cm²) against air excess factor α (X-axis, a non-dimensional value) upon heating of specimens of titanium alloy Ti—6 Al—4V;

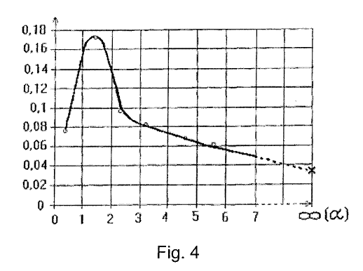

FIG. 5 is a graph of the volume of heat-transfer elements in the regenerating headpiece in the form of corund balls with a diameter of 20 mm (Y-axis, m³) against fuel consumption, in this case, consumption of natural gas (X-axis, m³/h) at values of the air excess factor α ranging from 2.0 to 7.0;

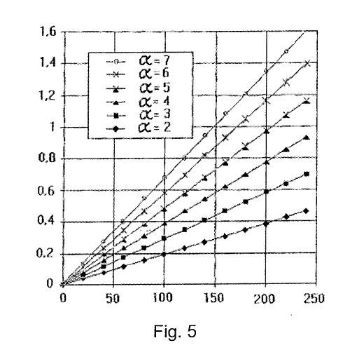

FIG. 6 is a simplified block diagram of the device for heating of a directly-fired furnace in accordance with the third variant, with two burners, two regenerating headpieces—each of which is executed in accordance with the first variant of regenerating headpiece—and a four-input reversing valve in the exchange system;

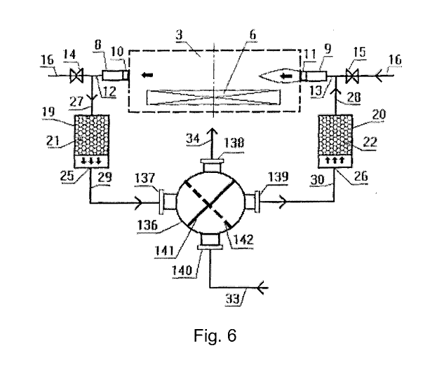

FIG. 7 is a diagram of the regenerating headpiece in accordance with the second variant, with sequentially arranged and interconnected sections of the interior space of the regenerating headpiece, for operation at different air excess factors a varying in the course of operation;

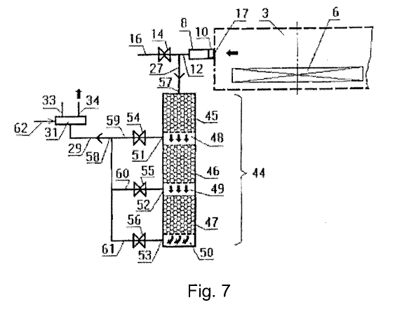

FIG. 8 is a diagram of the regenerating headpiece in accordance with the third variant, with interior spaces of the regenerating headpiece arranged parallel to each other, for operation at different air excess factors a varying in the course of operation;

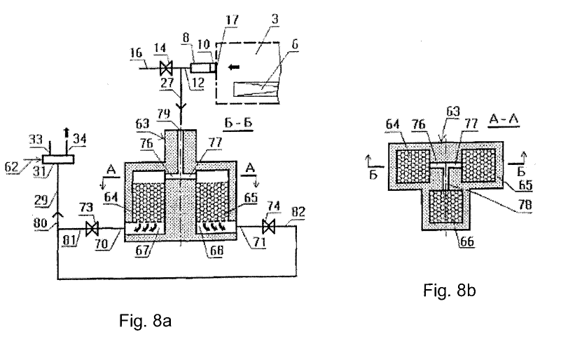

FIG. 9 is a device for the heating of an indirectly-fired furnace with a radiant tube;

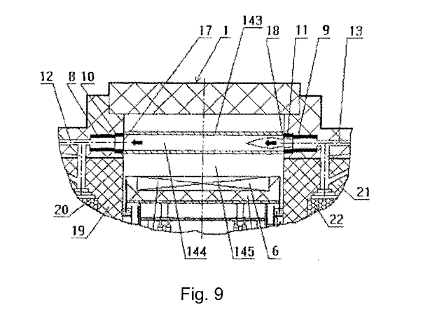

FIG. 10 is a device for the heating of an indirectly-fired furnace with a melting pot;

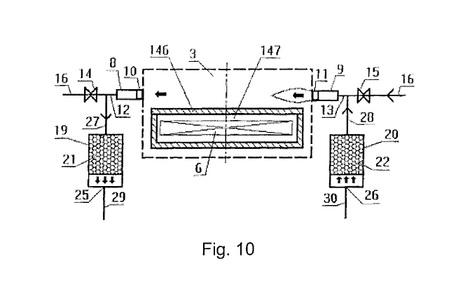

FIG. 11 is the left part of a diagram of a trial scheme for the implementation of the offered method;

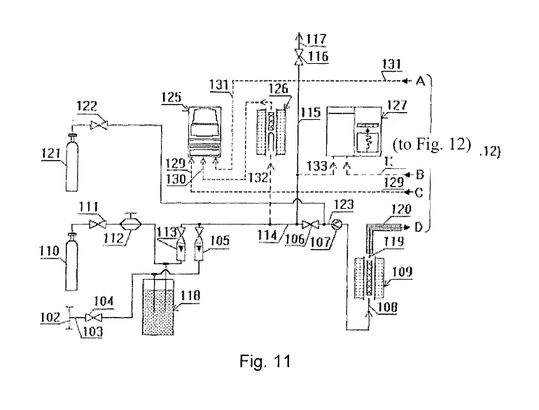

FIG. 12 is the right part of a diagram of a trial scheme for the implementation of the offered method.

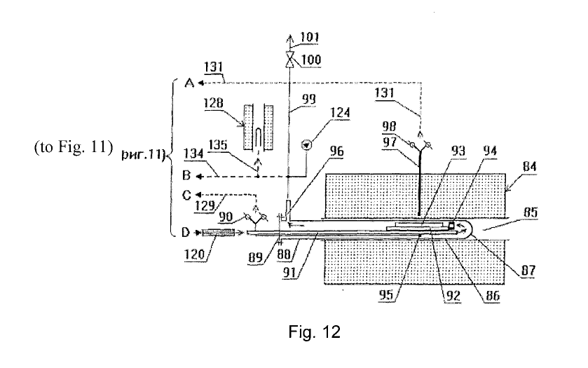

### DESCRIPTION

Disclosure of the invention. The methods and devices below differ from their prototypes and are offered to attain the above-mentioned objectives.

A method of metal heat treatment in a directly- or indirectly-fired furnace (the first variant of the method) based on a combustion of a mixture of liquid or gas fuel and heated air at a certain value of the air excess factor, characterized in that that the specified mixture of fuel and air is burned at a value of the air excess factor exceeding 2.0 and primarily set within a range of up to 6.0.

A method of metal heat treatment in a directly- or indirectly-fired furnace (the second variant of the method) based on a combustion of a mixture of liquid or gas fuel and heated air, including the heating of metal to an intermediate temperature, the subsequent heating of metal to an operating temperature, and the holding of the metal at an operating temperature. In addition, the specified mixture of fuel and heated air is burned, at least upon the heating of the metal to an intermediate temperature at a value of the air excess factor not exceeding 2.0. The method is characterized in that the treatable metal is heated to an operating temperature upon an increase in the air excess factor to a value exceeding 2.0 and falling primarily within a range of up to 6.0. In addition, the holding of the metal at an operating temperature is performed at a constant or variable value of the air excess factor exceeding 2.0 and falling mainly within a range of up to 6.0.

A method of combustion of a mixture of liquid or gas fuel and heated air in a directly- or indirectly-fired furnace at a certain value of the heating air excess factor (the third variant of the method) characterized in that the specified mixture of fuel and air is burned at a value of the air excess factor exceeding 2.0 and primarily set within a range of up to 6.0.

A device for the heating of a directly- or indirectly-fired furnace (the first variant of the furnace design), including a heated space with a window for the removal of the combustion products, at least one burner for the burning of gas or liquid fuel mixed with heated air at a certain fuel to heated air ratio, characterized by a relevant value of the air excess factor and a system for the heating of air and supply to each of the burners in the required amount—the required amount being one in which the value of the air excess factor exceeds 2.0 and is set mainly within a range of up to 6.0.

A device for the heating of a directly- or indirectly-fired furnace (the second variant of the furnace design) that includes a heated space, two burners for the burning of gas or liquid fuel (mixed with heated air at a certain fuel to heated air ratio characterized by a relevant value of the air excess factor), a duct for the supply of gas or liquid fuel, a duct for the removal of the cooled combustion products, a system for the heating of air and supply to each of the burners, and a system of control and exchange of the ducts, burners and regenerating headpieces. The burners include a duct for the supply of air from the outside and two regenerating headpieces. Each of the headpieces has an interior space with two input-output windows filled with a layer of heat-transfer elements of a certain amount. The design of the system of control and exchange allows the performance of cyclically changing functions by the burners and the regenerating headpieces. Namely, during one operation cycle of the device for the heating of a combustion furnace, each of the regenerating headpieces is used for the heating of the heat-transfer elements using hot combustion products. And during the other cycle, each of them heats air using the heat-transfer elements heated during the previous cycle. During one operation cycle of the device for the heating of a combustion furnace, each of the burners performs the functions of a burner. And during the other cycle, each of them functions as a window for the removal of the combustion products from the heated space. The device is characterized in that the interior space of each of the regenerating headpieces is filled with such a layer of heat-transfer elements volume that corresponds with the following formula:

V=K·α·B₁,

where V stands for the volume of the layer of heat-transfer elements filling the interior space of the regenerating headpiece, m³; K stands for the proportionality factor depending on the type of fuel, type and size of the heat-transfer elements, the temperature of air and combustion products in the input-output windows of the regenerating headpiece, and the duration of the operation cycle of the device for the heating of combustion furnace, h; a stands for the air excess factor chosen depending on the required mode of heat treatment in a combustion furnace that exceeds 2.0 and falls primarily within a range of up to 6.0, a non-dimensional value; B₁ stands for fuel consumption (gas or liquid fuel) per burner where α=1, m³/h.

A device for the heating of a directly- or indirectly-fired furnace (the third variant of the furnace design) that includes a heated space, two burners for the burning of gas or liquid fuel (mixed with heated air at a certain ratio of fuel to heated air characterized by a relevant value of the air excess factor), and two regenerating headpieces. Each of headpieces has an interior space with two input-output windows filled with a layer of heat-transfer elements of a certain amount. Each of the burners is connected to a duct for the supply of gas or liquid fuel through a rectifier, and is also connected with one of the input-output windows of one of the regenerating headpieces. The other input-output window of each of the headpieces is connected to a duct for the supply of air and to a duct for the removal of the combustion products through each of headpieces individually, a three-input reversing valve, or through both of the headpieces in combination, a four-input reversing valve. The device is characterized in that the interior space of each of the regenerating headpieces is filled with such a layer of heat-transfer elements volume that corresponds with the following formula:

V=K·α·B₁,

where V stands for the volume of the layer of heat-transfer elements filling the interior space of the regenerating headpiece, m³; K stands for the proportionality factor depending on the type of fuel, the type and size of heat-transfer elements, the temperature of air and combustion products in the input-output windows of the regenerating headpiece, and the duration of the operation cycle of the device for the heating of a combustion furnace, h; a stands for the air excess factor chosen depending on the required mode of heat treatment in a combustion furnace that exceeds 2.0 and falls primarily within a range of up to 6.0, a non-dimensional value; B₁ stands for fuel consumption (gas or liquid fuel) per burner where α=1, m³/h.

A regenerating headpiece of a directly- or indirectly-fired furnace (the first variant of the headpiece) heated with a burned mixture of liquid or gas fuel and heated air at a certain fuel to heated air ratio, characterized by a relevant value of the air excess factor, and including an interior space with two input-output windows filled with a layer of heat-transfer elements of a certain amount. It is characterized in that the interior space of the regenerating headpiece is filled with a layer of heat-transfer elements volume that corresponds with the following formula:

V=K·α·B₁,

where V stands for the volume of a layer of heat-transfer elements filling the interior space of the regenerating headpiece, m³; K stands for the proportionality factor depending on the type of fuel, the type and size of heat-transfer elements, the temperature of air and combustion products in the input-output windows of the regenerating headpiece, and the duration of the operation cycle of the device for heating of combustion furnace, h; a stands for the air excess factor chosen depending on the required mode of heat treatment in the combustion furnace that exceeds 2.0 and falls primarily within a range of up to 6.0, a non-dimensional value; B₁ stands for fuel consumption (gas or liquid fuel) per regenerating headpiece where α=1, m³/h.

A regenerating headpiece of a directly- or indirectly-fired furnace (the second variant of the headpiece) heated with a burned mixture of liquid or gas fuel and heated air at a certain fuel to heated air ratio, characterized by a relevant value of the air excess factor, and including an interior space filled with heat-transfer elements and connected to an under-headpiece space located beneath it. In addition, the specified interior space has one input-output window in the upper part and the mentioned under-headpiece space has another input-output window with a shut-off valve. The headpiece is characterized in that the interior space filled with heat-transfer elements is designed in the form of several (at least two) sections located one under the other. Each of the sections, except for the bottommost, is connected to the underlying section with the help of an additional under-headpiece space located between these sections. The additional space has an additional input-output window with an additional shut-off valve. Each section of the interior space is filled with a layer of heat-transfer elements of a certain volume, the total volume of which corresponds with the formula:

Vₘₐₓ=K·αₘₐₓ·B₁,

where Vₘₐₓ stands for the total volume of the layers of heat-transfer elements of all sections of the interior space of the regenerating headpiece, m³; K stands for the proportionality factor depending on the type of fuel, the type and size of heat-transfer elements, the temperature of air and the combustion products in the input-output windows of the regenerating headpiece, and the duration of the operation cycle of the device for the heating of a combustion furnace, h; αₘₐₓ stands for the maximum air excess factor of the regenerating headpiece chosen depending on the required mode of heat treatment in the combustion furnace that exceeds 2.0 and falls primarily within a range of up to 6.0, a non-dimensional value; B₁ stands for fuel consumption (gas or liquid fuel) per regenerating headpiece where α=1, m³/h; In addition, the maximum air excess factor of the regenerating headpiece and the air excess factors for each section of the interior space of the regenerating headpiece are related to each other by the formula:

αₘₐₓ=Σ αᵢ,

where αᵢ stands for the chosen value of the air excess factor of section i of the interior space of the regenerating headpiece, a non-dimensional value; i stands for ordinal number of sections of the interior space of the regenerating headpiece, varying from 1 to n, where n equals the number of sections of the interior space of the regenerating headpiece; and the volume of the layer of heat-transfer elements filling each section of the interior space corresponds with the formula:

Vᵢ=K·αᵢ·B₁,

where V, stands for volume of the layer of heat-transfer elements of section i of the interior space of the regenerating headpiece, m³ (variable i and members K, B₁ are defined above).

A regenerating headpiece of a directly- or indirectly-fired furnace (the third variant of the headpiece) heated with a burned mixture of liquid or gas fuel and heated air at a certain fuel to heated air ratio, characterized by a relevant value of the air excess factor, and includes the first interior space filled with a layer of heat-transfer elements of a certain volume, with two input-output windows. The upper window is connected to the upper input-output window of the regenerating headpiece. The bottom window has the first shut-off valve. The headpiece is characterized in that the regenerating headpiece is fitted with at least one additional interior space filled with a layer of heat-transfer elements of a certain volume. The additional space has its own under-headpiece space, and upper and bottom input-output windows. The upper window is connected to the upper input-output window of the regenerating headpiece. The bottom window is fitted with an additional shut-off valve. In addition, the total volume of the layers of heat-transfer elements in all interior spaces of the regenerating headpiece corresponds with the formula:

Vₘₐₓ=K·αₘₐₓB₁ᵣ,

where Vₘₐₓ stands for the total volume of layers of heat-transfer elements of all interior spaces of the regenerating headpiece, m³; K stands for the proportionality factor depending on the type of fuel, the type and size of heat-transfer elements, the temperature of air and the combustion products in the input-output windows of regenerating headpiece, and the duration of the operation cycle of the device for the heating of a combustion furnace, h; αₘₐₓ stands for the maximum air excess factor of the regenerating headpiece chosen depending on the required mode of heat treatment in the combustion furnace that exceeds 2.0 and falls primarily within a range of up to 6.0, a non-dimensional value; B₁ stands for fuel consumption (gas or liquid fuel) per regenerating headpiece where α=1, m³/11; In addition, the maximum air excess factor of the regenerating headpiece and the air excess factors for each interior space of the regenerating headpiece are related to each other by the formula:

αₘₐₓ=Σ αᵢ,

where αᵢ stands for the chosen value of the air excess factor of interior space i of the regenerating headpiece, a non-dimensional value; i stands for the ordinal number of the interior space of the regenerating headpiece, varying from 1 to n, where n equals the number of interior spaces of the regenerating headpiece; and the volume of the layer of heat-transfer elements filling each interior space corresponds with the formula:

Vᵢ=K·αᵢ·B₁,

where Vᵢ stands for volume of the layer of heat-transfer elements of interior space i of the regenerating headpiece, m³ (variable i and members κ, B₁ are defined above).

Novelty of all the offered methods and devices is reflected in new technical features introduced into the prototypes. They relate to ensuring the values of the air excess factor α exceeding 2.0 and falling primarily within a range of up to 6.0. For methods, these new technical features consist of new modes for the implementation of the offered methods, and, for devices, they refer to new design features functionally described for the system of air heating for a combustion furnace according to the first variant of heating device. Alternatively, they relate to the features characterized (for other variants of device) by the volume of heat-transfer elements located in the interior spaces (or sections) of the regenerating headpieces of combustion furnaces.

Based on experimental evidence obtained by the authors of the present invention, we specify below a new, surprising (in terms of technical level), and unpredictable technical result from the employment of the offered technical decisions, according to which, fuel is burned in directly- or indirectly-fired furnaces at high values of the air excess factor (α exceeds 2.0). The obtained interesting technical result provides a new glance at the efficiency of the existing methods for the control of scaling, and the de-carbonization and hydrogen absorption of metals. It is also indicative of the comprehensive approach to the solution for these problems.

The employment of all the offered variants of the method and devices for the heat treatment of metals and products (ingots, blanks, etc.) of steel and non-ferrous alloys, and of titanium alloys (in particular, in a directly- or indirectly-fired furnace), ensures a significant reduction of metal waste as compared with the prototype, as shown in the below examples of the method of implementation: for St steel, reduction amounts to 40%, for titanium alloy, Ti—6 Al—4V metal waste is reduced almost 2.5 times.

The reduced level of metal waste upon heating, in accordance with the offered invention, is comparable to the level of burning loss upon air heating in an electric furnace. However, in the heating of furnaces with natural gas, the unit cost of heating of 1 tonne of products is several times lower than the unit cost of electric heating [the above-specified work of M. A. Kasenkov, pages 434-435, as well as article “ [symbol] [symbol] [symbol] [symbol] [symbol] [symbol] [symbol] [symbol] [symbol] [symbol] [symbol] [symbol] [symbol] [symbol] [symbol] ”, [symbol] [symbol] , [symbol] [symbol] , [symbol] [symbol] , [symbol] [symbol] ., [symbol] E. B., [symbol] B. A. [symbol] [symbol] , [symbol] [symbol] [symbol] [symbol] [symbol] [symbol] : [symbol] [symbol] [symbol] , [symbol] [symbol] [symbol] [symbol] 300- [symbol] [symbol] [symbol] 80- [symbol] [symbol] [symbol] [symbol] [symbol] [symbol] “ [symbol] [symbol] [symbol] [symbol] [symbol] ”, [symbol] , 2000, [symbol] . 265÷272 (Issues of Energy Saving upon Heating of Products of Titanium and Aluminium Alloys Prior to Chipless Shaping, M. D. Kazyaev, V. P. Markin, V. G. Lisienko, N. B. Loshkarev, E. V. Kiselev, V. A. Savelyev, V. Ya. Tsimerling, collected book Thermal Physics and Information Science in Metallurgy: Problems and Achievements, Materials of international conference devoted to the 300^{th} anniversary of metallurgy in the Urals, the 80^{th} anniversary of the Faculty of Metallurgy and Department of Thermal Physics and Information Science in Metallurgy, Ekaterinburg, 2000, pages 265÷272)].

Moreover, the reduction in the hydrogen absorption of metals and their alloys, for example, titanium and titanium alloys, magnesium and magnesium alloys, steel, is ensured.

The specified technical result of the offered methods and devices of direct or indirect heating is achieved by ensuring the relevant composition of the medium (gas phase) of combustion products, the mixture of hot air and liquid or gas fuel at the proposed values of the air excess factor α exceeding 2.0. In particular, the revealed decrease in the concentration (partial pressure) of water vapor, even upon increase in concentration (partial pressure) of oxygen, is responsible for the reduction in the burning loss and hydrogen absorption of metals.

The employment of the offered methods and devices in reverberatory directly-fired furnaces for the melting of non-ferrous metals will also allow for an increase in metal yield on account of the reduction of the burning loss.

The employment of the offered methods and devices in indirectly-fired furnaces ensures a longer service life of the muffles (radiant tubes, melting pots) as well as a relevant reduction of the operating expenses and production costs of metals heat treatment on account of the reduction of the burning loss of muffle walls.

Upon heat treatment of the metal and non-metal products using the offered methods and devices in directly- or indirectly-fired furnaces with the air excess factor exceeding 2.0, an increased volume of air is supplied to the heated space of the furnace or to the radiant tube. In addition, the convectional component of heat exchange increases on account of an increase in the rate of movement of the combustion products in the heated space of the furnace or in the radiant tube. The result is a reduction in the time of heat transfer from the combustion products to the products treated in the combustion furnace and an increase in furnace capacity. The reduction in the heating time ensures an additional reduction of the burning loss, an the de-carbonization and hydrogen absorption of heated metals.

The reduced cost of the heat treatment of metals upon fired heating and the achieved comparability of levels of burning loss (obtained using the offered methods and the known method of metal air heating in an electric furnace) ensures an expansion of the scope of application of the offered method and the devices implementing it, and a substitution of the known method of the heat treatment of metals in electric furnaces for the offered method.

The second variant of the method for the heat treatment of metals in a directly- or indirect-fired furnace (three-stage heating with variable value of α) is more economic as compared to the one-stage first variant (with constant value of α). At the first stage of implementation of the second variant of the method, upon heating to an intermediate temperature when the temperature of the metal surface is rather low (for example, for steel it does not exceed 650÷800° C.) and the oxidation process progresses slowly, it is impractical to increase the value of the air excess factor and to use electric power to supply/remove the increased volumes of the air and combustion products. Burning loss increases (virtually exponentially) with an increase in temperature at the second and third stages of the method of implementation (heating to operating temperature and holding at operating temperature), and one has to control it via an increase in the value of the air excess factor α and a supply of a relevant additional amount of heated air to the burner. In addition, the power costs are offset by the decrease in the metal oxidation in the furnace and a corresponding increase in the metal yield. A similar effect is attained upon heat treatment of hydrogen-charged metals.

The first variant of the device for the heating of a directly- or indirectly-fired furnace is the most general of all offered the devices, assuring solubility of the set task. It is ensured on account of the design of the system of air heating and supply to each burner in the required amount. It allows for the heating and supplying of air in an amount ensuring a value of the air excess factor exceeding 2.0 and set primarily within a range of up to 6.0. This variant presupposes the use of at least one burner in the combustion furnace. A supply of heated air to this burner may be ensured both with the help of the regenerating headpieces, alternatively operating in pulse mode, and by using the recuperator or electric heater for the heating of air in continuous mode.

The second variant of the device for the heating of a directly- or indirectly-fired furnace complies with an optimal design of a combustion furnace attaining the objective of the invention. It includes two burners, alternatively operating for the burning of fuel, two regenerating headpieces, and a system of control and exchange ensuring an alternative operation of each regenerating headpiece for the heating of air supplied to the burners (cyclic pulse mode). Each of the headpieces ensures the implementation of the offered methods of heating of a combustion furnace at the air excess factor α exceeding 2.0 (primarily ranging up to 6.0).

The third variant of the device for the heating of a directly- or indirectly-fired furnace complies with a design of the combustion furnace attaining the objective of the invention. It includes two burners, alternatively operating for the burning of fuel, and two regenerating headpieces and reversing valves (two three-input or one four-input). The valves are used as one of the designs of the exchange system, ensuring an alternative operation of each regenerating headpiece for the heating of air supplied to the burners in cyclic pulse mode. Each of the headpieces ensures the implementation of the offered methods of heating of a combustion furnace at the air excess factor α exceeding 2.0 (primarily ranging up to 6.0).

The offered variants of the regenerating headpiece of a directly- or indirectly-fired furnace solves the set task using elements (parts) of the offered combustion furnace for the heating of metal.

The first variant of the regenerating headpiece corresponds with the most general of the offered designs of such headpieces, ensuring the implementation of the offered methods of the heating of a directly- or indirectly-fired furnace at the air excess factor α exceeding 2.0 (ranging primarily to 6.0) for the volume of heat-transfer elements in the interior space of the headpiece specified in the patent claim.

The second variant of the regenerating headpiece consists of a design of the regenerating headpiece with the positioning of several sections of the interior space of the regenerating headpiece (filled with heat-transfer elements) one under the other. The sections are interconnected with the help of additional under-headpiece spaces, in such a way that the specified sections are located successively in relation to each other so that the flow of heated air or cooled products from the combustion of fuel-and-air mixture runs through a headpiece at the specified volume of heat-transfer elements in each section of the interior space of the headpiece. The presence of the input-output window, with the shut-off valve in each additional under-headpiece space of each section, allows for an opportunity to put one or the other sequence of sections into operation and, consequently, to use the regenerating headpiece in the second variant of the offered method at various values of the air excess factor α, including values exceeding 2.0 (ranging primarily up to 6.0).

The third variant of the regenerating headpiece is a design of the regenerating headpiece with several interior spaces of the regenerating headpiece filled with heat-transfer elements, parallel to each other and to allow the flow of gas. Each of the interior spaces has its under-headpiece space and an input-output window with a shut-off valve. The presence of the shut-off valve ensures an opportunity to cut off the process of air heating in any of the interior spaces of the headpiece, that is, an opportunity to employ this headpiece at different values of the air excess factor α, variable in the process of implementation of the second variant of the offered method, including values exceeding 2.0 (ranging primarily up to 6.0).

Thus, the second and the third variants of the regenerating headpiece can be used with the implementation of the second variant of the method of heat treatment of metals in directly- or indirectly-fired furnaces, including three-stage heating with a variable value of a. The employment of such regenerating headpieces upon heating, with a variable value of the air excess factor α, reduces the thermal inertia of the headpiece upon changes in factor α, as the design of these headpieces ensures changes in the value of factor α, via the physical alteration of the volume of heat-transfer elements of the headpiece in operation. It decreases the influence of the air (heated in the headpiece) on the temperature in the furnace, and ensures an increase in the maintenance stability of the preset temperature conditions when heat treating metal.

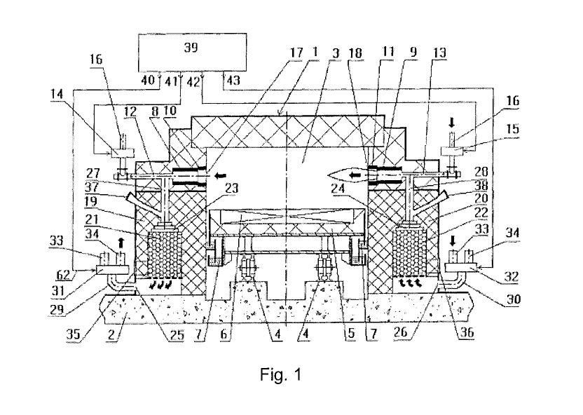

The best mode of invention design. Illustrated in FIG. 1 is a furnace 1 for the heat (thermal) treatment of metal, operating with a constant, invariable value of the air excess factor (in the course of heat treatment) that corresponds with the first and second variants of the device for heating of a directly-fired furnace. It includes two burners, two regenerating headpieces—each of which is executed in accordance with the first variant of the regenerating headpiece—and two three-input reversing valves in the system of control and exchange. This is the first variant of the offered method of metal heat treatment at a constant, invariable value of the air excess factor α (in the course of heat treatment), and is optimally implemented.

Furnace 1 is set on a foundation 2. It has a heating device including a heated space 3 (also referred to as work space) in which the platform (bottom) 5 with heat treated metal 6 is located on wheels (rails) or rollers 4. Products of ferrous or non-ferrous metals and their alloys can be inserted into the furnace 1 for heat treatment. Sand locks (seals) 7 between the platform 5 and a heated space 3 wall ensure the sealing of the heated space 3. The heating device includes burners set in the lining of the furnace 1: the first burner 8 is on the left, the second burner 9 is on the right. Each burner (8, 9) has a burner stone (10, 11, respectively), an ignition device (not indicated on the diagram) and a duct (gas lances) 12, 13 for the supply of gas fuel that is connected to another duct (common pipeline) 16 for the supply of gas fuel to the furnace 1 and operated by a two-input, pilot-operated shut-off valve 14, 15.

In the described design of the combustion furnace 1, the output window (burner stone) 17, 18 of each burner 8, 9 is used as a source of the burner flame if the burner is on. If the burner is off, it functions as a window for the removal of hot combustion products from the work space (heated space) 3 of the furnace 1.

In the lining of the furnace 1, two regenerating headpieces are set: the first headpiece 19 is located to the left of vertical symmetry axis of the furnace, the second headpiece 20 is placed to the right of the axis. Each of the headpieces 19, 20 is designed in the form of a lined chamber with interior space 21, 22 filled with heat-transfer elements, for example, in the form of a layer of corund or metal balls. The Interior space 21, 22 of each headpiece 19, 20 has an upper input-output window 23, 24 and a bottom input-output window 25, 26. Heat-transfer elements in the interior space 21 (22) of each headpiece 19 (20) are embedded on a grate under which there is an under-headpiece space with a bottom input-output window 25 (26).

Each of the regenerating headpieces 19 (20) illustrated in FIG. 1 refers to the first variant of the headpiece regarded as an invention. Its design presupposes that it can contain a heat-transfer elements volume in its interior space 21 (22) that complies with the invention. It ensures a target value of the air excess factor exceeding 2.0 and falling mainly within the range of up to 6.0. No device for the measurements of the specified volume of heat-transfer elements, directly in the process of metal heat treatment, is foreseen in these headpieces (19, 20).

During one operation cycle of the device for the heating of the combustion furnace, each of the headpieces 19, 20 is used for the heating of heat-transfer elements, or corund balls, in particular, with hot combustion products. During the other cycle, each of them is used for the heating of air using the heat-transfer elements heated during the previous cycle. To make such operation of the headpieces possible, the upper input-output window 23 (24) of the headpiece 19 (20) is connected with a duct 12 (13) of the burner 8 (9) with the help of another duct 27 (28) and with the output window 17 (18) of the burner 8 (9) through this duct 12 (13). The bottom input-output window 25 (26) of the headpiece 19 (20) is connected with a duct 33 for the supply of “cold”, unheated air from outside (air source, fan are not indicated) and with a duct 34 for the removal of cooled combustion products. The connection is ensured through a three-input, pilot-operated reversing valve 31 (32) with the help of a pipe junction 29 (30). A duct 34 is connected with a smoke exhauster and a chimney stack (not indicated in the diagram).

The shut-off valve 14 (15) has two positions—open and closed. The Open valve 14 (15) ensures the supply of gas fuel from the duct 16 to the burner 8 (9). The Closed valve 14 (15) shuts off the supply of fuel to the burner. At the same time, the closed valve prevents the escape of combustion products supplied to the window 17 (18) of the burner 8 (9) from the heated space 3 of the furnace 1, and directs these combustion products to the interior space 21 (22) of the headpiece 19 (20) through the duct 27 (28) and the upper input-output window 23 (24).

The three-input reversing valve 31 (32) also has two positions—the first and the second. In the first position, the valve 31 (32) ensures the connection of the bottom input-output window 25 (26) of the headpiece 19 (20) with the duct 34 for the removal of cooled combustion products from the headpiece 19 (20) through the pipe junction 29 (30). In the second position, the valve 31 (32) ensures the connection of the bottom input-output window 25 (26) of the headpiece 19 (20) with the duct 33 for the supply of cold air to the headpieces 19, 20 through the pipe junction 29 (30).

If either burner 8 (9) is on, the duct 27 (28) of the headpiece 19 (20) serves to supply heated air from the headpiece 19 (20) to the burner 8 (9). If the burner 8 (9) is off, combustion products from the work space 3 of the furnace 1 are supplied to headpiece 19 (20) through the duct 27 (28). Thus, air heated in the interior space 21, 22 of the headpiece 19, 20 flows in each headpiece from the bottom on up (according to FIG. 1), while hot combustion products move in the interior space 21, 22 of the headpiece 19, 20 from the top on down.

To remove scale from the heat-transfer elements and to remove them from the headpiece 8 (9), a window 35 (36) is located in the bottom part of each headpiece and a door 37 (38) is located in the upper part of each headpiece, used also for the loading of new heat-transfer elements. The removal or loading of heat-transfer elements with the help of the doors 37 (38) and windows 35 (36) takes about 20-30 minutes. In practice, these operations are usually performed when servicing the furnace 1, during a pause between the metal heat treatment operations.

There is a control module 39 to manage the operation of the device for the heating of the furnace 1. The outputs 40, 41, 42 and 43 of this module are connected with control inputs of the valves 31, 14, 15 and 32, respectively. To make the fuel supply to the burners 8, 9 synchronous, the control module 39 for the ignition of fuel and heated air mixture has corresponding connections with the ignition devices of the burners 8, 9 (not indicated on the diagram). The control module 39 determines the cycles of operation of the burners 8, 9 and the regenerating headpieces 19, 20.

In this case, the system of air heating and supply to the burner 8 (9) in the required amount includes a duct 33 for the supply of air from the outside, a duct 34 for the discharge of cooled combustion products and two regenerating headpieces 19, 20.

Each of the headpieces has an interior space 21, 22 with two input-output windows 23, 25 and 24, 26 are filled with a layer of corund balls, used as heat-transfer elements, of a certain volume. The input-output windows 23, 26 of the regenerating headpieces 19, 20 are connected with the duct 33 for the supply of air from the outside, the output window 17, 18 of heated space in the furnace 1, the burners 8, 9, and the duct 34 for removal of cooled combustion products, as specified above. The details of the design for the best mode of the invention, the filling of the regenerating headpieces with heat-transfer elements, the calculations of the parameters of the regenerating headpieces, and the operation of the device are specified below.

What is claimed is:

1. A method of heat treatment of metal in a directly- or indirectly-fired furnace, based on the combustion of a mixture of liquid or gas fuel and heated air at a certain value of the air excess factor, characterized in that the specified mixture of fuel and air is burned at a value of the air excess factor exceeding 2.0 and primarily set within a range of up to 6.0.

2. A method of heat treatment of metal in a directly- or indirectly-fired furnace, based on the combustion of a mixture of liquid or gas fuel and heated air including the heating of the metal to an intermediate temperature, subsequent heating of the metal to an operating temperature, and holding of the metal at the operating temperature; wherein, the specified mixture of fuel and heated air is burned at least upon the heating of the metal to an intermediate temperature at a value of the air excess factor not exceeding 2.0; characterized in that, that the treated metal is heated to an operating temperature upon increase in the air excess factor to a value exceeding 2.0 and falling primarily within the range of up to 6.0; and wherein, holding at the operating temperature is performed at a constant or variable value of the air excess factor exceeding 2.0 and falling mainly within a range of up to 6.0.

3. A method of combustion of a mixture of liquid or gas fuel and heated air in a directly- or indirectly-fired furnace at a certain value of the air excess factor, characterized in that, that the specified mixture of fuel and air is burned at a value of the air excess factor exceeding 2.0 and primarily set within a range of up to 6.0.

4. A device for the heating of a directly- or indirectly-fired furnace comprising a heated space with a window for the discharge of combustion products, at least one burner for the burning of gas or liquid fuel mixed with heated air at a certain fuel to heated air ratio characterized by a relevant value of the air excess factor and a system for the heating of air and its supply to each of the burners in the required amount; characterized further in that the design of the system of air heating and its supply to each of the burners in the required amount allows for the heating and supply of air in an amount ensuring a value of the air excess factor exceeding 2.0 and set mainly within a range of up to 6.0.

5. A device for the heating of a directly- or indirectly-fired furnace comprising a heated space, two burners for the burning of gas or liquid fuel mixed with heated air at a certain fuel to heated air ratio characterized by a relevant value of the air excess factor, a duct for the supply of gas or liquid fuel, a duct for the discharge of cooled combustion products, a system for the heating of air and its supply to each of burners including a duct for the supply of air from outside and two regenerating headpieces; wherein, each of the headpieces has an interior space with two input-output windows filled with a layer of heat-transfer elements in a certain amount and a system for the control and exchange of specified ducts, burners and regenerating headpieces, and designed with a performance ability involving the cyclical changing of functions between burners and regenerating headpieces; wherein, each of regenerating headpieces is used for the heating of the heat-transfer elements using hot combustion products during one operation cycle of the unit for the heating of the combustion furnace, in particular, it is used for the heating of air using the heat-transfer elements heated during the previous cycle; wherein, each of the burners function as burners during one operation cycle of the unit for the heating of the combustion furnace and as a window for the removal of combustion products from the heated space during the other operation cycle; said device is characterized in that, that the interior space of each of regenerating headpieces is filled with a layer of heat-transfer elements volume corresponding with the following formula:
V=K·α·B₁,
where V stands for the volume of the layer of heat-transfer elements filling the interior space of the regenerating headpiece, m³; K stands for the proportionality factor depending on the type of fuel, the type and size of the heat-transfer elements, the temperature of air and combustion products in the input-output windows of the regenerating headpiece, and the duration of the operation cycle of the unit for the heating of the combustion furnace, h; α stands for the air excess factor chosen depending on the required mode of heat treatment in the combustion furnace that exceeds 2.0 and falls primarily within a range of up to 6.0, a non-dimensional value; and B₁ stands for fuel consumption (gas or liquid fuel) per burner where α=1, m³/h.

6. A device for the heating of a directly- or indirectly-fired furnace comprising a heated space, two burners for the burning of gas or liquid fuel mixed with heated air at a certain fuel to heated air ratio characterized by a relevant value of the air excess factor, and two regenerating headpieces; wherein each of headpieces has an interior space with two input-output windows filled with a layer of heat-transfer elements in a certain amount; wherein each of the burners is connected to a duct for the supply of gas or liquid fuel through a rectifier and is also connected to one of the input-output windows of one of the regenerating headpieces; wherein, the other input-output window of each of the headpieces is connected to a duct for the supply of air, and to a duct for the removal of the combustion products through each of the headpieces individually, a three-input reversing valve, or through both of the headpieces in combination, a four-input reversing valve; said device is characterized in that the interior space of each of the regenerating headpieces is filled with a layer of heat-transfer elements volume that corresponds with the following formula:
V=K·α·B₁,
where V stands for volume of the layer of heat-transfer elements filling the interior space of the regenerating headpiece, m³; K stands for the the proportionality factor depending on the type of fuel, the type and size of heat-transfer elements, the temperature of air and combustion products in the input-output windows of the regenerating headpiece, and the duration of the operation cycle of the unit for the heating of the combustion furnace, h; α stands for the air excess factor chosen depending on the required mode of heat treatment in the combustion furnace that exceeds 2.0 and falls primarily within a range of up to 6.0, a non-dimensional value; B₁ stands for the fuel consumption (gas or liquid fuel) per burner where α=1, m³/h.

7. A regenerating headpiece of a directly- or indirectly-fired furnace heated with a burned mixture of liquid or gas fuel and heated air at a certain fuel to heated air ratio characterized by a relevant value of the air excess factor comprising an interior space with two input-output windows filled with a layer of heat-transfer elements in a certain amount; characterized in that, that the interior space of the regenerating headpiece is filled with a layer of heat-transfer elements volume that corresponds with the following formula:
V=K·α·B₁,
where V stands for the volume of the layer of heat-transfer elements filling the interior space of the regenerating headpiece, m³; K stands for the proportionality factor depending on the type of fuel, the type and size of the heat-transfer elements, the temperature of air and combustion products in the input-output windows of the regenerating headpiece, and the duration of the operation cycle of the unit for heating of the combustion furnace, h; a stands for the air excess factor chosen depending on the required mode of heat treatment in the combustion furnace that exceeds 2.0 and falls primarily within a range of up to 6.0, a non-dimensional value; B₁ stands for the fuel consumption (gas or liquid fuel) per regenerating headpiece where α=1, m³/h.

8. A regenerating headpiece of a directly- or indirectly-fired furnace heated with a burned mixture of liquid or gas fuel and heated air at a certain fuel to heated air ratio characterized by a relevant value of the air excess factor comprising an interior space filled with heat-transfer elements and connected with an under-headpiece space located under it; wherein, the interior space has an input-output window in the upper part and the under-headpiece space has another input-output window with a shut-off valve; wherein, the headpiece is characterized in that the interior space filled with heat-transfer elements is designed in the form of several—at least two—sections located one under the other, each of which, with the exception of the bottommost section, is connected with an underlying section with the help of an additional under-headpiece space located between these sections; wherein, each of these additional spaces has an additional input-output window with an additional shut-off valve; wherein, each section of the interior space is filled with a layer of heat-transfer elements of a certain volume, with the total volume corresponding with the following formula:
Vₘₐₓ=K·αₘₐₓ·B₁,
where Vₘₐₓ stands for the total volume of layers of the heat-transfer elements of all sections of the interior space of the regenerating headpiece, m³; K stands for the proportionality factor depending on the type of fuel, the type and size of heat-transfer elements, the temperature of air and the combustion products in the input-output windows of the regenerating headpiece, and the duration of the operation cycle of the unit for the heating of a combustion furnace, h; αₘₐₓ stands for the maximum air excess factor of the regenerating headpiece chosen depending on the required mode of heat treatment in the combustion furnace that exceeds 2.0 and falls primarily within a range of up to 6.0, a non-dimensional value; B₁ stands for the fuel consumption (gas or liquid fuel) per regenerating headpiece where α=1, m³/h; wherein, the, maximum air excess factor of the regenerating headpiece and the air excess factors for each section of the interior space of the regenerating headpiece are related to each other by the formula:
αₘₐₓ=Σ αᵢ,
where αᵢ stands for the chosen value of the air excess factor of section i of the interior space of the regenerating headpiece, a non-dimensional value; i stands for the ordinal section number of the interior space of the regenerating headpiece, varying from 1 to n where n equals the number of sections of the interior space of the regenerating headpiece; and wherein, the volume of the layer of heat-transfer elements filling each section of the interior space corresponds with the formula:
Vᵢ=K·αᵢ·B₁,
where Vᵢ stands for volume of the layer of heat-transfer elements of section i of the interior space of the regenerating headpiece, m³ (variable i and members K, B₁ are defined above).

9. A regenerating headpiece of a directly- or indirectly-fired furnace heated with a burned mixture of liquid or gas fuel and heated air at a certain fuel to heated air ratio characterized by a relevant value of the air excess factor comprising a first interior space filled with a layer of heat-transfer elements of a certain volume with two input-output windows, where the upper window is connected with the upper input-output window of the regenerating headpiece and the bottom window has the first shut-off valve; wherein, the headpiece is characterized in that the regenerating headpiece is fitted with at least one additional interior space filled with a layer of heat-transfer elements of a certain volume; wherein, the additional space has its own under-headpiece space and upper and bottom input-output windows, where the upper window is connected with the upper input-output window of the regenerating headpiece and the bottom window is fitted with an additional shut-off valve; wherein, the total volume of layers of heat-transfer elements in all interior spaces of the regenerating headpiece corresponds with the formula:
Vₘₐₓ=K·αₘₐₓ·B₁ᵣ,
where Vₘₐₓ stands for the total volume of layers of heat-transfer elements of all interior spaces of the regenerating headpiece, m³; K stands for the proportionality factor depending on the type of fuel, the type and size of heat-transfer elements, the temperature of air and the combustion products in the input-output windows of the regenerating headpiece, and duration of the operation cycle of the unit for the heating of the combustion furnace, h; αₘₐₓ stands for the maximum air excess factor of the regenerating headpiece chosen depending on the required mode of heat treatment in the combustion furnace that exceeds 2.0 and falls primarily within a range of up to 6.0,
a non-dimensional value; B₁ stands for fuel consumption (gas or liquid fuel) per regenerating headpiece where α=1, m³/h; wherein, the maximum air excess factor of the regenerating headpiece and the air excess factors for each interior space of the regenerating headpiece are related to each other by the formula:
αₘₐₓ=Σ αᵢ,
where αᵢ stands for the chosen value of the air excess factor of interior space i of the regenerating headpiece, a non-dimensional value; i stands for ordinal number of the interior space of the regenerating headpiece, varying from 1 to n where n equals the number of interior spaces of the regenerating headpiece; and wherein, the volume of the layer of heat-transfer elements filling each of interior spaces corresponds with the formula:
Vᵢ=K·αᵢ·B₁,
where Vᵢ stands for the volume of the layer of heat-transfer elements of interior space i of the regenerating headpiece, m³ (variable i and members K, B₁ are defined above).
